(19) United States
(12) Patent Application Publication
(10) Pub. No.: US 2010/0135009 A1
(43) Pub. Date: Jun. 3, 2010

(54) CUSTOM COLOR LED REPLACEMENTS FOR TRADITIONAL LIGHTING FIXTURES

(76) Inventors: David Duncan, Troy, NY (US); Daniel Landry, Troy, NY (US); David Socha, Glenmont, NY (US)

Correspondence Address: HOFFMAN WARNICK LLC, 75 STATE STREET, 14TH FLOOR, ALBANY, NY, 12207, US

(21) Appl. No.: 12/579,829

(22) Filed: Oct. 15, 2009

Related U.S. Application Data
(60) Provisional application No. 61/105,466, filed on Oct. 15, 2008.
(60) Provisional application No. 61/117,932, filed on Nov. 25, 2008.

(51) Int. Cl. F21V 9/00

(52) U.S. Cl. 362/231

(57) ABSTRACT

A system useful as a light bulb replacement fixture is presented comprising a light bulb replacement fixture; at least one light emitting diode connected to the light bulb replacement fixture; and at least one quantum dot for absorbing light of a first wavelength emitted by the at least one light emitting diode and emitting light of a second wavelength.

### CROSS-REFERENCE TO RELATED APPLICATIONS

This application claims the benefit of co-pending U.S. Provisional Application Nos. 61/105,466, filed 15 Oct. 2008, and 61/117,932, filed 25 Nov. 2008, each of which is hereby incorporated herein.

### TECHNICAL FIELD

The present invention relates to light emitting diodes (LEDs) comprising semiconductor nanocrystals, or more specifically, quantum dots, as a replacement for traditional incandescent, fluorescent, and halogen light bulbs and fixtures.

### BACKGROUND OF THE INVENTION

Light emitting diodes (LEDs) have become a desirable replacement for traditional lighting methods, including incandescent, fluorescent, and halogen lighting. Compared to these types of lights, LEDs are much more energy efficient and can have much longer product lifetimes. However, the materials used to make LEDs typically limit the colors possible in an LED lighting application.

Semiconductor nanocrystals are typically tiny crystals of II-VI, III-V, IV-VI, or I-III-VI materials that have a diameter between about 1 nanometer (nm) and about 20 nm. In the strong confinement limit, the physical diameter of the nanocrystal is smaller than the bulk excitation Bohr radius, causing quantum confinement effects to predominate. In this regime, the nanocrystal is a 0-dimensional system that has both quantized density and energy of electronic states where the actual energy and energy differences between electronic states are a function of both the nanocrystal composition and physical size. Larger nanocrystals have more closely spaced energy states and smaller nanocrystals have the reverse. Because interaction of light and matter is determined by the density and energy of electronic states, many of the optical and electric properties of nanocrystals can be tuned or altered simply by changing the nanocrystal geometry (i.e. physical size).

Single nanocrystals or monodisperse populations of nanocrystals exhibit unique optical properties that are size tunable. Both the onset of absorption and the photoluminescent wavelength are a function of nanocrystal size and composition. The nanocrystals will absorb all wavelengths shorter than the absorption onset. However, photoluminescence will always occur at the absorption onset. The bandwidth of the photoluminescent spectra is due to both homogeneous and inhomogeneous broadening mechanisms. Homogeneous mechanisms include temperature-dependent Doppler broadening and broadening due to the Heisenberg uncertainty principle, while inhomogeneous broadening is due to the size distribution of the nanocrystals. The narrower the size distribution of the nanocrystals is, the narrower the full-width at half max (FWHM) of the resultant photoluminescent spectra will be. In 1991, Brus wrote a paper reviewing the theoretical and experimental research conducted on colloidally-grown semiconductor nanocrystals, such as cadmium selenide (CdSe), in particular. (Brus L., Quantum Crystallites and Nonlinear Optics, Applied Physics A, 53 (1991)). That research, precipitated in the early 1980's by the likes of Efros, Ekimov, and Brus himself, greatly accelerated by the end of the 1980s, as demonstrated by the increase in the number of papers concerning colloidally-grown semiconductor nanocrystals in past years.

### SUMMARY OF THE INVENTION

A first aspect includes a system comprising: a light bulb replacement fixture; at least one light emitting diode connected to the light bulb replacement fixture; and at least one quantum dot for absorbing light of a first wavelength emitted by the at least one light emitting diode and emitting light of a second wavelength.

The semiconductor nanocrystals, or quantum dots more specifically, useful in the present invention are described in the commonly-owned applications Ser. Nos. 11/125,120 and 11/125,129. These quantum dots comprise a core semiconductor with a thin metal layer to protect from oxidation and to aid lattice matching, and a shell to enhance the luminescent properties, especially for the II-VI or III-V materials. Non-limiting examples of semiconductor nanocrystal cores include ZnS, ZnSe, ZnTe, CdS, CdSe, CdTe, HgS, HgSe, HgTe (II-VI materials), PbS, PbSe, PbTe (IV-VI materials), AlN, AlP, AlAs, AlSb, GaN, GaP, GaAs, GaSb, InN, InP, InAs, InSb, InGaP (III-V materials), CuInGaS₂, CuInGaSe₂, AgInS₂, AgInSe₂, and AuGaTe₂ (I-III-VI materials). The metal layer is often formed of Zn or Cd, and the shell may be of the same material as the core or any of the above listed core materials.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustration of light emitting diodes coated with quantum dots in a light bulb replacement fixture according to an embodiment of the invention.

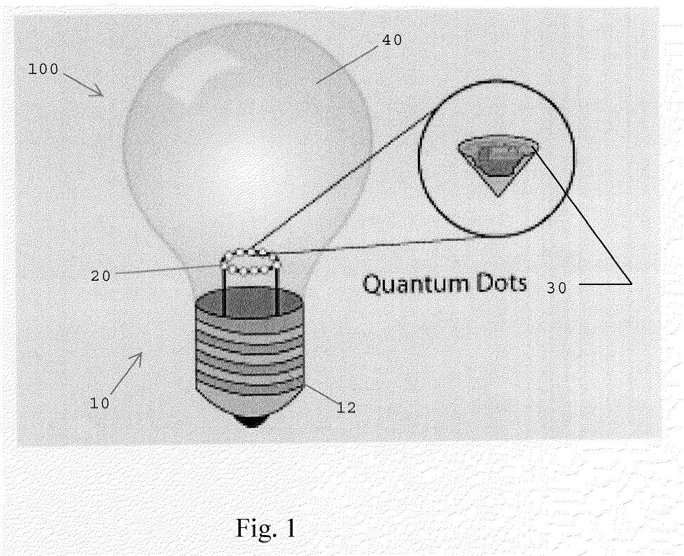

FIG. 2 shows an illustration according to an alternative embodiment wherein the quantum dot layer is on an enclosure.

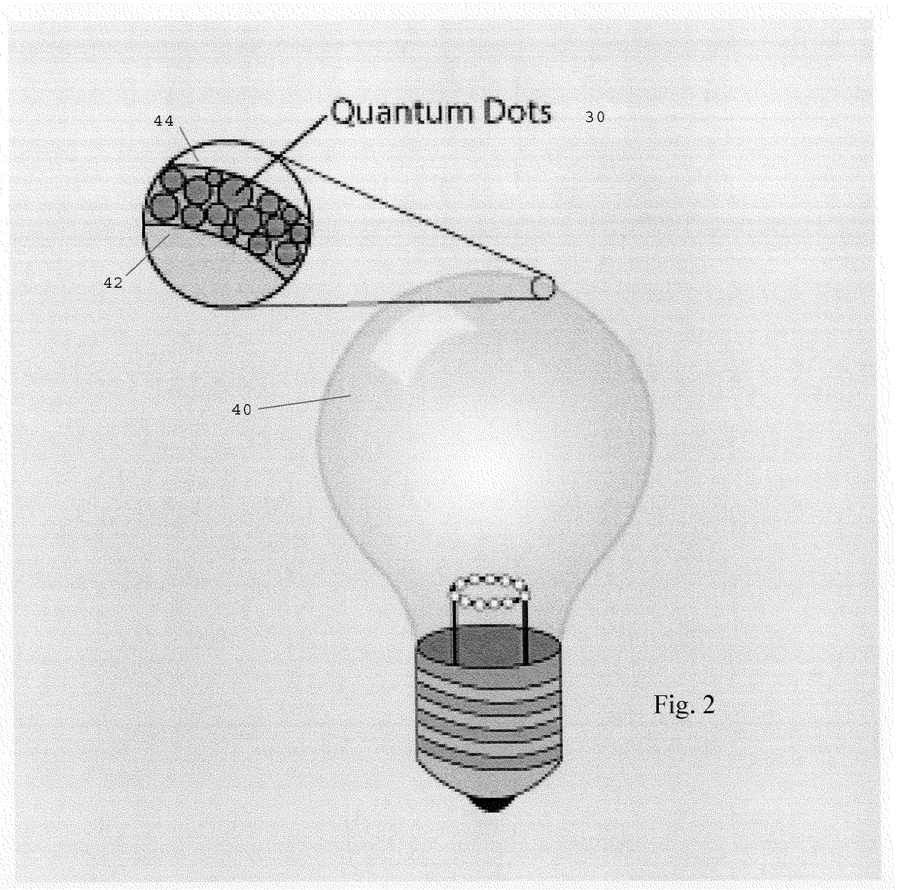

FIG. 3 shows an illustration of an alternative embodiment wherein quantum dot coatings are on the light emitting diodes and on the enclosure.

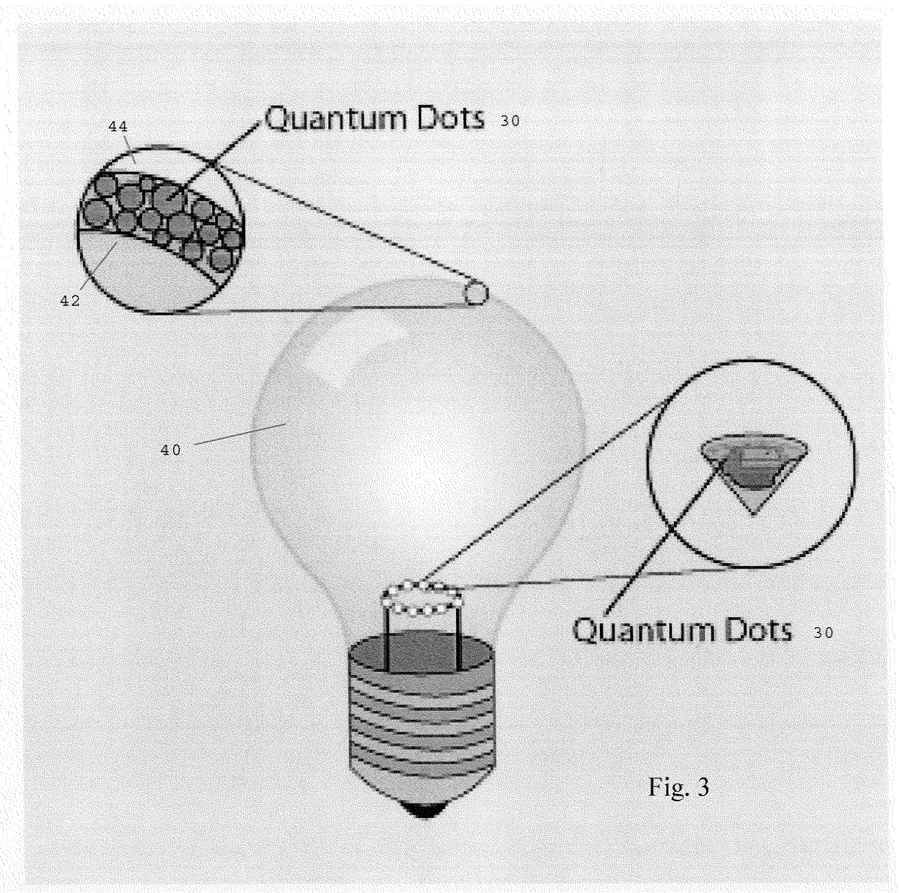

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

A system 100 is presented comprising a light bulb replacement fixture 10. It is understood that this may include any fixture now known or later developed in which a replacement bulb may be used. Some examples include, but are not limited to, incandescent replacement bulbs, night lights, outdoor solar lighting fixtures, both residential and commercial exterior lighting, holiday lighting bulb replacements, automotive lighting fixtures, both residential and commercial interior lighting, theatrical lighting, lighted doorbells, signage, and flashlights, to name just a few.

In a further embodiment the light bulb replacement fixture 10 includes at least one light emitting diode 20. As can be appreciated, this may consist of a single light emitting diode or a group of light emitting diodes, which may be arranged in a cluster or in some pattern. In one embodiment, small lighting applications such as warning lights in automotive lighting may only require a single light emitting diode. However, in another embodiment, a plurality of light emitting diodes may be necessary or desirable. When more than one light emitting diode is employed for certain embodiments, it should be understood that any number or grouping of the light emitting diodes may be utilized. In some embodiments, such as signage, a pattern may be formed using the light emitting diodes. The light emitting diode may be any known light emitting diode, which vary in size and color.

The light emitting diode or diodes may further include at least one quantum dot 30 (which may comprise a quantum dot coating) on or above at least one light emitting diode 20. The method of coating a light emitting diode is further described in commonly-owned U.S. Provisional Application No. 61/117,932, filed 25 Nov. 2008, which is hereby incorporated herein. It should be noted that the at least one quantum dot 30 alters the color emitted by the light emitting diode 20. Quantum dots, as described above, can be selected so as to absorb the light emitted from the light emitting diode 20, either in its entirety or some portion of the light, and reemit the light in the emission range of the quantum dots. This may result in the light emitting diode 20 emission being the frequency of the quantum dot 30 or some combination of the original light of the light emitting diode 20 and the quantum dot emission. Depending on the color desired from the replacement fixture, one or more of the light emitting diodes may be coated, or all of the diodes may be coated. In further embodiments, different light emitting diodes may be coated with separate, specific color quantum dots. The resulting light may form patterns of different colors or blend to create specific colors. The type of quantum dot used may also vary based on the color or application of the light fixture replacement.

In some embodiments the quantum dot 30 may be at least one selected from a group consisting of: II-VI materials, III-V materials, IV-VI materials, I-III-VI materials, and combinations thereof. It is understood that different sizes of each group of quantum dots results in different colors, and different groups of materials have different color ranges. A combination of at least one of sizes and groups of quantum dots can be combined to result in a custom color output from the light bulb replacement fixture 10.

Further, in some light replacement applications, the system 100 may comprise a light bulb replacement fixture 100 having a threaded portion 12 which is electrically connected to the light emitting diode 20. In many embodiments, a light bulb replacement fixture may be required to be screwed into a light socket, such as incandescent replacements. In such an embodiment, the light emitting diode assembly is electrically connected to a threaded portion. In an embodiment, the threaded portion 12 fits into a traditional light bulb-receiving fixture. In other embodiments, the light bulb replacement fixture may comprise other connection methods, such as two-pronged connections and any other now-known or later-developed light bulb connection. It is understood that the size and power of the receiving fixture, or socket, may vary and any now-known or later-developed fixtures can be fitted with a replacement bulb fixture in accordance with embodiments of the invention.

In a further embodiment, the system 100 may include an enclosure 40 over the light emitting diode 20 or diodes. In some embodiments, the enclosure 40 may be a traditional bulb, as is common in most household lighting fixtures. In other embodiments, the enclosure 40 may comprise a microlens array. It should be understood that there exist many light enclosures in the art that are within the scope of the invention. It should also be noted that a quantum dot coating may be contained in or on the enclosure 40, as in the case when the quantum dot coating is above the light emitting diode 20. In such embodiments, a quantum dot layer could be included as a coating on either the inside surface 42 or outside surface 44 of the enclosure 40. Alternatively, the quantum dot layer could be incorporated in the material of the enclosure 40 itself; for example, as a glass matrix including quantum dots suspended in the glass.

In another embodiment, the system may comprise a lighting apparatus, such as a lamp. This may include traditional desk lamps or in some alternative embodiments, interior lighting fixtures such as ceiling lights or recessed lighting apparatus. Further, in another embodiment the lighting apparatus may include at least one device, such as a dial or a switch. The dial and/or switch may alter at least one of the input voltage, current, resistance, and power to at least one light emitting diode, so as to alter the output color of the at least one light emitting diode 20.

By varying voltage, current, and/or resistance, the light emitting diode 20 may change color, which will alter the color output of the quantum dot coating as well. Turning one or more light emitting diode 20 off will also result in an overall color change when the light fixture 10 includes more than one light emitting diode. Any combination of these effects may be utilized by moving the dial or switch to result in a dynamically colored light fixture. It should be understood that the dial and/or switch may be physically attached to a lighting apparatus, or it may be electrically connected, such as a wall switch that controls a light.

In some embodiments, a light emitting diode which may emit blue light can be altered to emit any of green, yellow, orange, red, white, or infrared light. An aqua colored light emitting diode can be altered to emit green light. A pink light emitting diode may be altered to emit purple. A green diode may be altered to emit yellow, orange, red, or infrared light. An ultraviolet (UV) light emitting diode can be altered to emit light of any wavelength or white light via a combination of quantum dots having different emitting frequencies. It is understood that this list is not an exhaustive list of color changes, but only a short list of examples of the colors achievable by altering an electrical property of the light replacement fixture.

Another embodiment of the invention may include a machine which may deposit quantum dots onto a light emitting diode. The machine may be programmable to deposit a specific type of quantum dot or size quantum dot in a specific concentration. In another embodiment the machine may deposit more than one type or size quantum dot in specific concentrations and in a specific ratio, so that nearly any color lighting fixture may be provided. It should be understood that such a machine could be calibrated in such a manner that the deposition of quantum dots is more consistent than that achievable by hand or eye.

The foregoing description of various aspects of the invention has been presented for the purpose of illustration and description. It is not intended to be exhaustive or to limit the invention to the precise form disclosed, and obviously, many modifications and variations are possible. Such variations and modifications that may be apparent to one skilled in the art are intended to be included within the scope of the present invention as defined by the accompanying claims.

What is claimed is:

1. A system comprising:
a light bulb replacement fixture;
at least one light emitting diode connected to the light bulb replacement fixture; and
at least one quantum dot for absorbing light of a first wavelength emitted by the at least one light emitting diode and emitting light of a second wavelength.

2. The system of claim 1, wherein the light bulb replacement fixture includes an enclosure.

3. The system of claim 2, wherein the at least one quantum dot comprises a quantum dot coating on at least one of the following: the at least one light emitting diode, an inner surface of the enclosure, or an outer surface of the enclosure.

4. The system of claim 2, wherein the at least one quantum dot is incorporated into the enclosure.

5. The system of claim 2, wherein the enclosure includes a microlens array.

6. The system of claim 1, wherein the first wavelength includes a blue light and the second wavelength includes light of at least one color selected from a group consisting of:
green, yellow, orange, red, and white.

7. The system of claim 1, wherein the first wavelength includes a blue light and the second wavelength includes an infrared light.

8. The system of claim 1, wherein the first wavelength includes an aqua light and the second wavelength includes a green light.

9. The system of claim 1, wherein the first wavelength includes a green light and the second wavelength includes light of at least one color selected from a group consisting of: yellow, orange, and red.

10. The system of claim 1, wherein the first wavelength includes a green light and the second wavelength includes an infrared light.

11. The system of claim 1, wherein the first wavelength includes a pink light and the second wavelength includes a purple light.

12. The system of claim 1, wherein the first wavelength includes an ultraviolet light and the second wavelength includes light of at least one color selected from a group consisting of: blue, pink, aqua, green, yellow, orange, red, and white.

13. The system of claim 1, wherein the light bulb replacement fixture comprises a threaded portion electrically connected to the light emitting diode.

14. The system of claim 13, wherein the threaded portion is compatible with a traditional light bulb receiving fixture.

15. The system of claim 1, further comprising:
a lighting apparatus; and
at least one device for altering at least one of the following: an input voltage, a current, a resistance, or a power to at least one of the light emitting diodes.

16. The system of claim 15, wherein altering the input voltage, the current, the resistance, or the power alters the first wavelength.

17. The system of claim 1, wherein the at least one quantum dot is selected from a group II-VI materials, III-V materials, IV-VI materials, I-III-VI materials, and combinations thereof.
